(19) United States
(12) Patent Application Publication
(10) Pub. No.: US 2004/0209610 A1
(43) Pub. Date: Oct. 21, 2004

(54) Method and apparatus for managing wireless terminals

(76) Inventors: Sandeep M. Adwankar, Schaumburg, IL (US); Nitya Narasimhan, Sehaumburg, IL (US); Venugopal Vasudevan, Palatine, IL (US)

Correspondence Address: VEDDER PRICE KAUFMAN & KAMMHOLZ, 222 N. LASALLE STREET, CHICAGO, IL, 60601, US

(21) Appl. No.: 10/418,457

(22) Filed: Apr. 17, 2003

(51) Int. Cl. H04M 3/00

(52) U.S. Cl. 455/419; 455/418

(57) ABSTRACT

A method and system for managing a terminal management system 10 including a terminal management network element 100 and at least one wireless terminal 20. The terminal management network element 100 includes a wireless terminal condition-based control information generator 120 that generates wireless terminal condition-based control information 16 represented by extensible markup language code. The wireless terminal condition-based control information 16 includes selected action data 46 and selected condition data 42 associated with a terminal management action to execute on at least one wireless terminal 20. The selected condition data 42 is associated with the selected action data 46 and selected attribute data 44. The selected attribute data 44 is associated with the selected action data 46. The wireless terminal 20 includes a wireless terminal condition-based controller 30 to execute the terminal management action if and when the selected condition data 42 associated with the terminal management action is satisfied.

### FIELD OF THE INVENTION

The invention relates generally to wireless communication systems, wireless terminals, and network elements and, more particularly, to the control and management of wireless terminals, and related methods.

### BACKGROUND OF THE INVENTION

With the growth of wireless terminals, there is a concurrent growth in managing wireless terminal operations. Wireless terminals, such as hand-held wireless devices, including but not limited to PDAs, cellular phones, pagers, smart phones, and other suitable devices, are known to employ limited protocols for managing terminal operations. Wireless terminal operations include operations such as diagnostic testing, software upgrades of the wireless terminal, and the reporting of wireless terminal functions, such as, for example, the reporting of the battery level on the wireless terminal to a network element.

For example, the Synchronization Markup Language (SyncML) protocol allows a wireless system operator to perform single terminal management actions for immediate execution on a given wireless terminal. However, the SyncML protocol does not allow for the performance of multiple terminal management actions at any given time, or for the conditional execution of terminal management actions, or for the delayed execution of terminal management actions. For example, the SyncML protocol does not allow for an operator to schedule execution of wireless terminal management actions at a predetermined time or upon a condition of a terminal or network to suit different conditions relating to different attributes of a mobile terminal or a condition of the network. As a result, the SyncML protocol does not support scheduling or conditional management control of the wireless terminal.

Another system proposes a policy-based management network that enforces a management policy through routers in a wired network. However, this system permits only “one-time” enforcement of the policy. Further, the policy in the management network addresses only one criterion. As a result, the policy is not dynamically enforceable or adaptable. Additionally, this policy-based management network executes within a router in a wired network and not in a wireless end-user device.

Other proposed systems, such as the “Simple Network Management Protocol” (SNMP), allow execution of an application based on a time of day. However, SNMP does not provide a mechanism for the conditional execution of a terminal management operation. Also, SNMP is designed for wired networks, and as such, requires each element in the network to comply with protocols such as the Transport Control Protocol (TCP) and User Datagram Protocol (UDP). As a result, SNMP is not appropriate for wireless devices because the controllers in these devices typically do not have the resources or capabilities to support these protocols. Consequently, SNMP would not be appropriate on a wireless device since (i) wireless devices typically do not support the TCP and UDP protocols; (ii) SNMP does not provide a mechanism for the conditional execution of a terminal management operation; and (iii) SNMP would require a wireless communication link with a large bandwidth.

### BRIEF DESCRIPTION OF THE DRAWINGS

The present invention is illustrated by way of example and not limitation in the accompanying figures, in which like reference numerals indicate similar elements, and in which:

FIG. 1 is a block diagram of a terminal management system in accordance with one exemplary embodiment;

FIG. 2 is a block diagram of the terminal management system shown in FIG. 1 according to another exemplary embodiment;

FIG. 3 is a flow chart of a method for managing at least one wireless mobile terminal according to another exemplary embodiment;

FIG. 4 is a block diagram of the wireless terminal of FIG. 1 shown in more detail according to one exemplary embodiment;

FIG. 5 is a flow chart for a method of receiving data according to one exemplary embodiment;

FIG. 6 is a flow chart of a method for processing information and attribute data according to one exemplary embodiment;

FIG. 7 is a flow chart of a method of processing a plurality of terminal management actions according to one exemplary embodiment;

FIG. 8 illustrates a user interface for a terminal management network element according to one exemplary embodiment;

FIG. 9 is a flow chart for executing a terminal management action according to one exemplary embodiment; and

FIG. 10 is a flow chart of a method for managing wireless terminals from a terminal management network element.

### DETAILED DESCRIPTION OF THE PREFERRED EMBODIMENT

A communication system and method employs wireless terminals, such as wireless mobile terminals, to determine that a condition associated with at least one terminal management action is satisfied based on extensible markup language code that includes at least wireless terminal condition-based control information. The wireless terminal condition-based control information includes at least terminal condition information and action data wherein the action data identifies at least one terminal management action associated with the wireless mobile terminal. The wireless terminal, in response to determining that a condition associated with the terminal management action is satisfied based on the received terminal condition information, conditionally executes the terminal management action identified by the received action data.

In one embodiment, the system and method described may be incorporated as an extension of the existing SyncML terminal management protocol in a non-invasive manner. For example, extension information, such as the condition data, attribute data, and action data, may be added to the SyncML terminal management protocol. These extensions to the existing SyncML payload are completely transparent to existing SyncML systems. As a result, systems capable of receiving the extension information will extract and interpret the extension information, while older systems will merely discard the extension information without error. Additionally, the extension to the existing SyncML protocol is extensible, and can therefore be easily customized or enhanced to address new requirements and criteria.

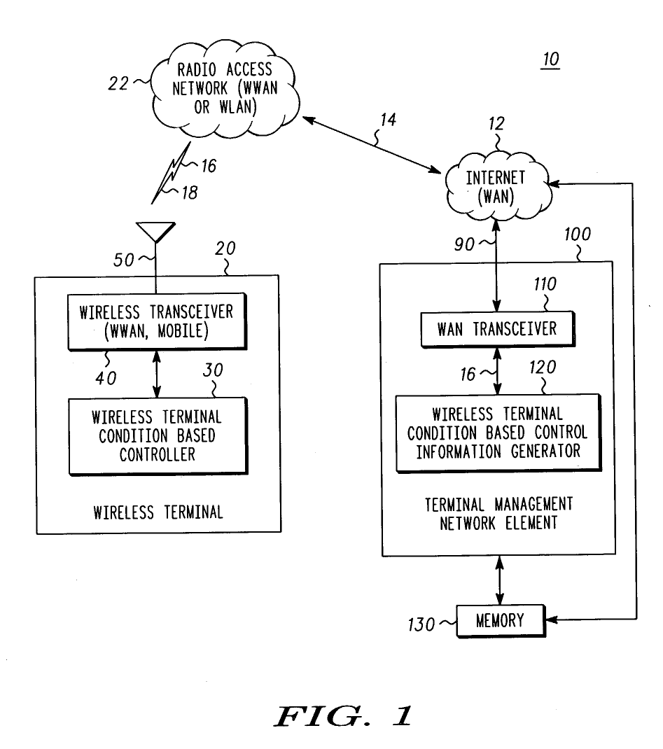

FIG. 1 illustrates one exemplary embodiment of a communication system 10 that includes, in this example, at least one wireless terminal 20, and a terminal management network element 100. The wireless terminal 20 is coupled to the terminal management network element 100 through a radio access network 22 such as a “wireless wide area network”, “wireless local access network”, or “wireless personal area network” (WWAN, WLAN, WPAN), and a wide area network (WAN) 12, such as the internet or other suitable network. Radio access network 22 and WAN 12 are operably coupled through a suitable communication link 14, such as an Ethernet link. Radio access network 22 may be any conventional communication network for transmitting wireless terminal condition-based control information 16, such as a CDMA wireless network, a 802.11(b) wireless network, a 3G telecommunications system, a bluetooth wireless network, or any suitable wireless network. Wireless terminal condition-based control information 16 includes condition data for conditionally executing terminal management actions.

The wireless terminal 20 may be a mobile telephone, a personal data assistant (PDA), wireless fidelity device (WiFi i.e. a device based on the IEEE 802.11 specification), blue tooth compliant device, personal computer, end device, or any other suitable communication device. Wireless terminal 20 includes wireless terminal condition-based controller 30 suitably coupled to wireless transceiver 40 for communication with radio access network 22. Wireless terminal condition-based controller 30 communicates with radio access network 22 via wireless transceiver 40, antenna 50, and radio communication link 18. Wireless terminal condition-based controller 30 identifies and executes the terminal management action and the condition associated with the terminal management action. The wireless terminal condition-based controller 30 may be one or more suitably programmed processors, such as a microprocessor, a microcontrolloer, or a digital signal processor, and therefore includes associated memory that contains executable instructions that when executed causes the wireless terminal condition-based controller 30 to carry out the operations described herein. In addition, the controller 30 as used herein may include discrete logic, a state machines or any other suitable combination of hardware, software and firmware.

Terminal management network element 100 includes wireless terminal condition-based control information generator 120 and WAN transceiver 110. WAN transceiver 110 couples wireless terminal condition-based control information generator 120 to wide area network 12 via communication line 90. Terminal management network element 100 may be any suitable network element, such as but not limited to a computer, such as a personal computer, server, or plurality of computers or servers.

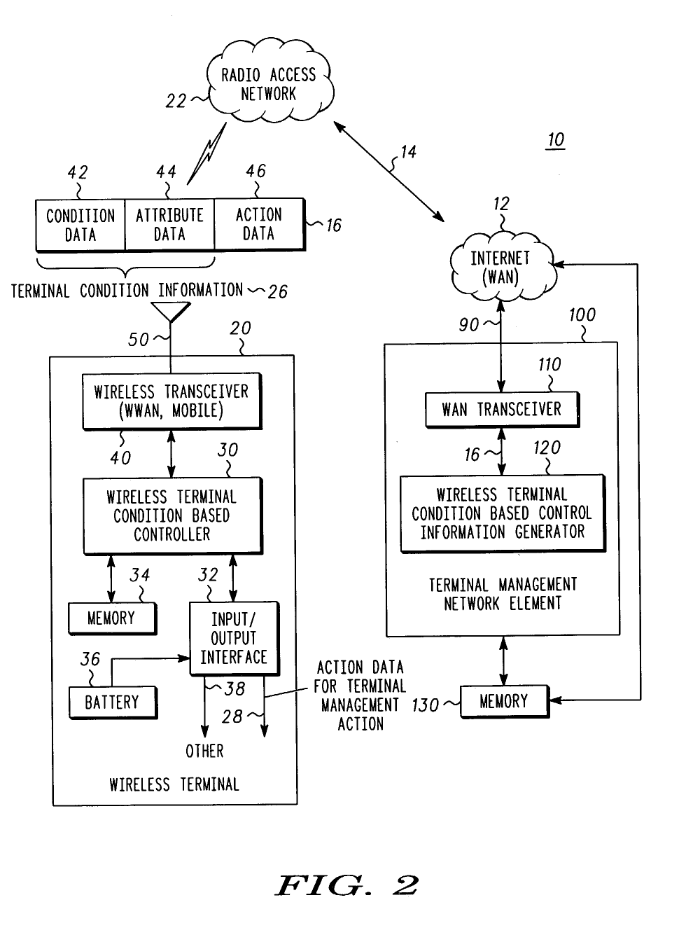

FIG. 2 illustrates the communication system 100 as shown in the embodiment of FIG. 1 in more detail. Wireless terminal 20 receives wireless terminal condition-based control information 16 that includes at least terminal condition information 26 and action data 46 associated with a terminal management action. Terminal condition information 26 includes condition data 42 and attribute data 44. Wireless terminal condition-based controller 30 is coupled to input/output (I/O) interface 32 and memory 34. Input/output interface 32 is coupled to exemplary wireless terminal battery 36, exemplary action data for terminal management action 28, and other 38 wireless terminal attribute interface data.

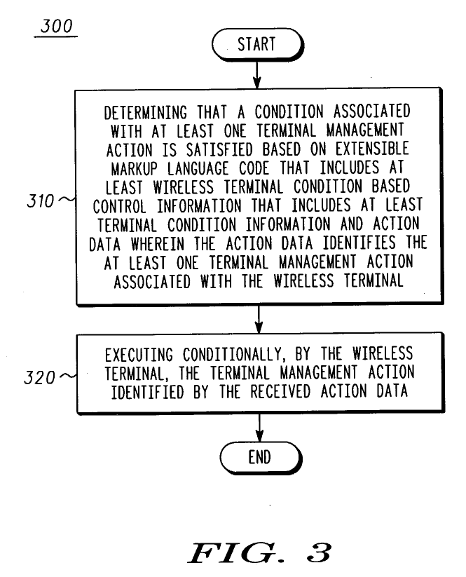

FIG. 3 illustrates one example of a method 300 for managing the operation of wireless terminal 20 in FIG. 1. At block 310, the wireless terminal 20 determines that a condition associated with at least one terminal management action is satisfied based on extensible markup language code that includes at least wireless terminal condition-based control information 16, that includes at least terminal condition information 26 and action data 46. The action data 46 identifies at least one terminal management action. The terminal management action performs terminal management operations on the wireless terminal 20, such as asset management, configuration management, fault management, and performance management. As shown in block 320, the wireless terminal conditionally executes the terminal management action identified by the received action data 46. The condition associated with the terminal management action may be an attribute and a condition associated with the wireless mobile terminal, such as a 25% battery level or an 847 area code.

Referring to the terminal management network element 100 and to memory 130 as shown in FIG. 2, instructions executable by a processor may be stored in computer readable memory 130 in order to cause the processor to perform the method 300 described in FIG. 3. These instructions executable by a processor include receiving the extensible markup language code that includes at least wireless terminal condition-based control information. As previously stated, the wireless terminal condition-based control information includes at least terminal condition information and action data where the action data identifies at least one terminal management action associated with the wireless mobile terminal. The instructions executable by the processor may conditionally execute the terminal management action identified by the action data in response to determining that a condition associated with the terminal management action is satisfied, based on the terminal condition information.

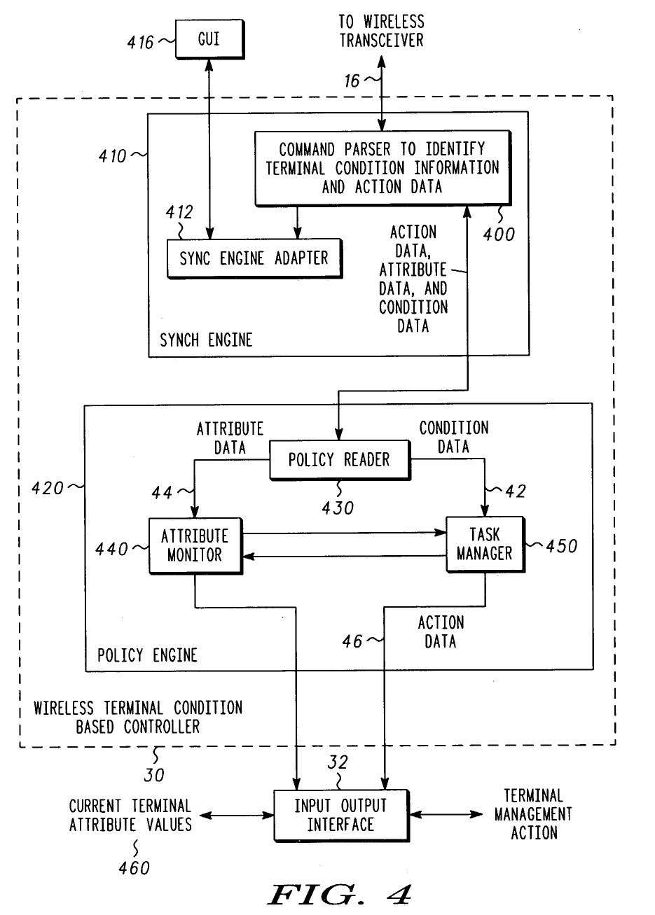

FIG. 4 illustrates wireless terminal condition-based terminal controller 30 coupled to an I/O interface 32 and Graphical User Interface (GUI) 416. Wireless terminal condition-based terminal controller 30, includes a Sync engine 410, and a policy engine 420. Sync engine 410 includes command parser 400 coupled to the wireless transceiver 40 to receive the wireless terminal condition-based control information 16. Command parser 400 parses the terminal condition information 16, and action data 46 associated with the wireless terminal action and identifies attribute data 44 associated with the action data 46 and condition data 42. In one embodiment, the condition data 42 includes a condition associated with an attribute such as less than, greater than, and equal to. For example, the attribute field may be a threshold level for performing a comparison.

Command parser 400 is coupled to GUI 416 via Sync engine adapter 412 to send, and receive information from a user. Information sent to the user may include, for example, queries, prompts and messages sent to the user via a display on the GUI 416 of wireless terminal 20. The GUI 416 may also provide information to the wireless terminal 20 via the Sync engine adapter 412 by providing information input from the user, such as a message, and data input via a keyboard on the wireless terminal 20.

As shown in FIG. 4, policy engine 420 includes a policy reader 430 coupled to the command parser 400 to read the action data 46, attribute data 44 and condition data 42 associated with the terminal management action 410. An attribute monitor 440 is coupled to the policy reader 430 to receive attribute data 44. Attribute monitor 440 is also coupled to I/O interface 32 to monitor current terminal attribute values 460 in response to the attribute monitor 440 receiving attribute data 44. Task manager 450 is coupled to the policy reader 430 and to the attribute monitor 440 to compare the current terminal attribute values 44 from the attribute monitor 440 with the received condition data 42 from the policy reader 430 to determine if the condition data 42 is satisfied. In order to perform this comparison, the attribute monitor 440 may receive current terminal attribute values 460 through: a polling event, an interrupt event, a predetermined time-of-day trigger event, or a predetermined period-of-elapsed- time trigger event. For example, wireless terminal condition-based controller 30 may include one or more processors to, for example, poll the I/O interface 32 in order to obtain the received current terminal attribute values 460. Alternatively, an interrupt event may be used to obtain current terminal attribute values 460 from I/O interface 32.

In one embodiment, the task manager 450 schedules a current terminal management action to execute, according to whether a previous terminal management action is completed. For example, the terminal management action may be a timed terminal management type of action wherein execution of the terminal management action is scheduled for a particular time of day. Alternatively, the current terminal management action schedule may be a periodic type of task.

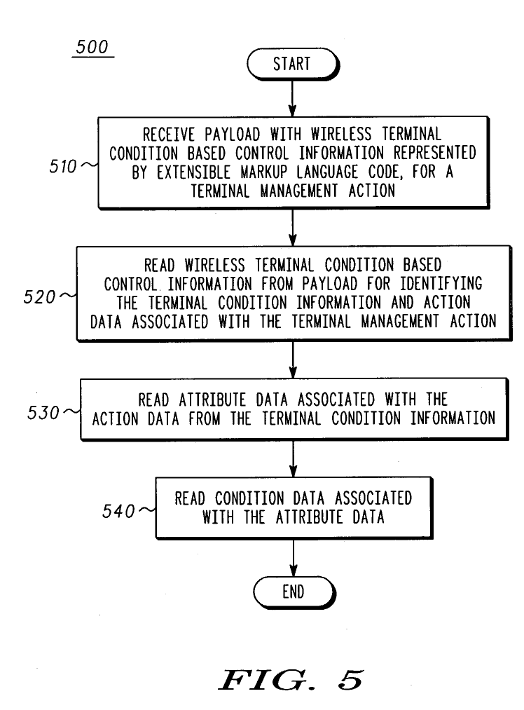

FIG. 5 is a block diagram for receiving a payload at block 510 with wireless terminal condition-based control information 16 represented by extensible markup language code for a terminal management action. Command parser 400 reads wireless terminal condition-based control information 16 from a payload at block 520, for identifying the terminal condition information 26 and action data 46 associated with the terminal management action. In this embodiment, the parser 400 of wireless terminal condition-based controller 30 reads attribute data 44 associated with the action data 46 from the terminal condition information 26, as shown in block 530. Additionally, at block 540, parser 400 reads condition data 42, associated with the attribute data 44.

In one embodiment, a terminal management action may depend on a battery-level guard operation that specifies a command for fetching an attribute such as the battery level from the wireless terminal 20. For example, the battery-level guard command may prevent execution of the terminal management action specified by the action data if the battery level on the terminal is below 25%. In this embodiment, the attribute of the terminal management action is the battery level, the condition is greater than 25%, and the action data represents a terminal management action. The guard command modifies the terminal condition information with a guard attribute. In this example, the guard attribute prevents execution of the terminal management action specified by the action data if the battery level on the wireless terminal 20 is below 25%. However, the guard command may be associated with any condition on the wireless terminal 20, such as signal strength, battery level, and the availability of the bearer network (i.e., General Packet Radio Service (GPRS)). In this example, the wireless terminal 20 may first determine if high data rate communication is available, such as in a GPRS network, by executing a data rate performance test. If high data rate communication is available, then an appropriate terminal management action requiring a high data rate may be executed. Alternatively, if high data rate communication is not available, then the guard command postpones or cancels execution of the terminal management action requiring the high data rate.

Examples of the terminal condition information associated with the terminal management action include a wireless terminal state (i.e., battery level as previously described) or a network state. For example, a network operator may want to run an automated test where all phones in the 847 area code receive a terminal management action, such as a test of wireless terminal functions. The operator may want to further execute the test on the first 100 mobiles to respond during off-peak hours so as not to drain terminals that are running low on battery power. Therefore, the network state may be the number of cell phones in the 847 area code running the requested terminal management action. The attribute therefore may be the test represented by the terminal management action. Other examples of terminal condition information include a duration since the last terminal management action occurred, a number of action repetitions, a completion of a terminal management action, a software upgrade, a time of day, a terminal management action schedule, a wireless application protocol (WAP) configuration, a user setting, a signal level, a battery level, and terminal location coordinates.

The wireless terminal condition-based control information 16, as shown in FIGS. 1 and 2, may be transmitted using extensible markup language code. In one embodiment, for example, the extensible markup language code may be based on the SyncML communications protocol described at www.syncml.org. However, any extensible markup language code may be used such as SGML, HTML, and XML.

Further, the extensible markup language code may include an assert command, a schedule command, and a perform command. The assert command may associate the terminal condition information 26 (condition data 42 and attribute data 44) with the received action data 46, and may also associate the terminal condition information 26 with exception action data if the condition data is not satisfied. For example, the assert command may cause the terminal management action to execute in the event the condition data is not satisfied. In another example of the assert command, the terminal management action may be a diagnostic test such as a test to determine if the browser is functioning properly. If the test results indicate that the browser is not functioning, then the browser may be automatically configured by, for example, configuring the WAP settings on the browser.

The schedule command may associate the terminal condition information with data such as a time of day, a time interval between successive executions of the terminal management action, a number of repetitions to execute the terminal management action, a repetition rate for executing the terminal management action, and a first run of a scheduled execution of a terminal management action. In one example, a terminal management action may be postponed for execution at a particular time. In another example, scheduling may take the form of monitoring, measuring and reporting an elapsed period of time to perform a terminal management action, such as downloading a web page. The wireless terminal may measure the amount of time a web page takes to download over a period of time, and for a number of occurrences, and report these measurements to the operator for statistical analysis. Accordingly, the report may be able to provide measurements over a period of time, or the average of the measurements over a period of time.

The perform command associates an attribute value such as a network attribute value, or a locally obtained attribute value associated with the wireless mobile terminal 20, and action data. For example, the perform command performs a non-local service action, such as a “get” terminal attribute value. Accordingly, an operator may use this command to measure service performance on a wireless mobile terminal.

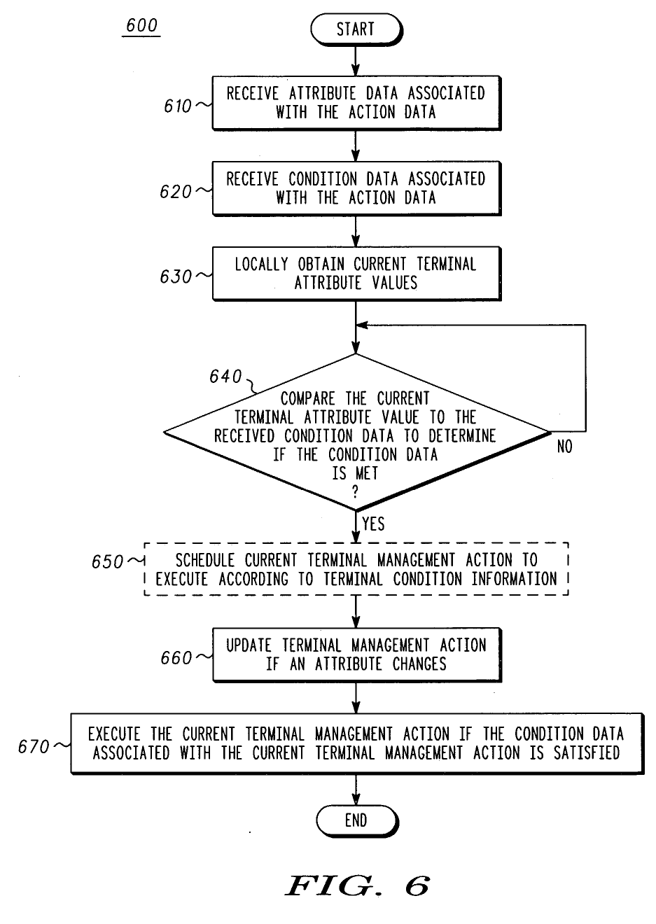

FIG. 6 is a block diagram for one embodiment of a method 600 to manage at least one wireless mobile terminal. The wireless terminal 20 receives attribute data 44 (i.e., via the command parser 400) associated with the action data at block 610. Condition data 42 associated with the attribute data 44 is received at block 620. The attribute monitor 440 receives locally obtained current terminal attribute values 460 (i.e., via the I/O interface 32) at block 630. As previously stated, the task manager 450 compares the locally obtained current terminal attribute values 460 with the received condition data 42 to determine if the condition data 42 is met at block 640. Optionally, for example, task manager 450 schedules a current terminal management action to conditionally execute, according to whether a previous terminal management action is completed. In this embodiment, the task manager 450 conditionally executes the current terminal management action if the condition data 42 associated with the terminal management action is met. In one exemplary embodiment, the condition data 42 requires that a previous terminal management action is executed at step 670 before the current terminal management action is executed. Since in this embodiment a current terminal management action may be scheduled to perform at a time in the future, the condition of the current terminal attribute values 460 may change by the time the current terminal management action is executed. Accordingly, the current terminal attribute values 460 may be updated at step 660 in order to determine if the condition data is still satisfied at that time.

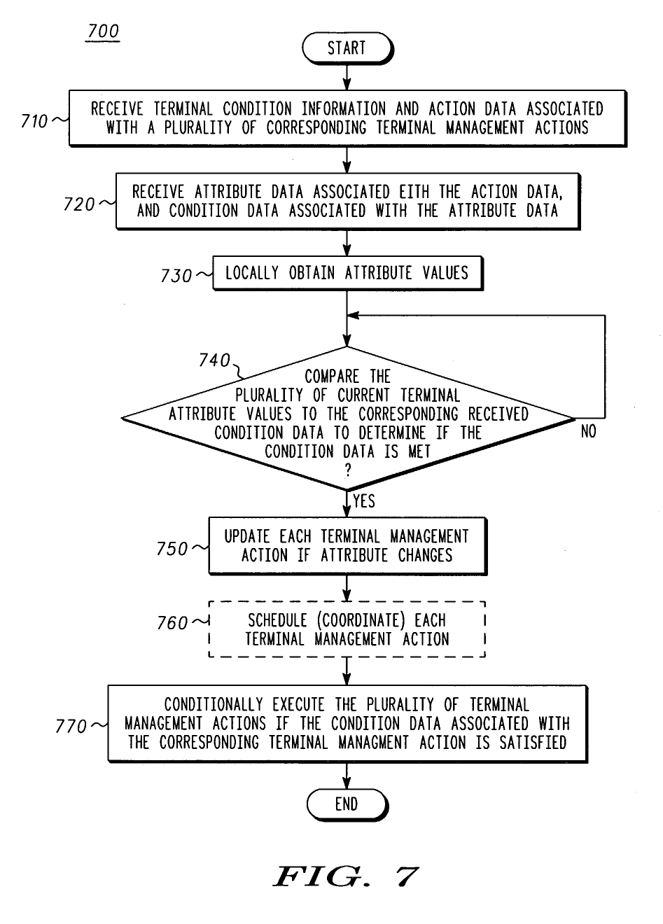

FIG. 7 is a block diagram of a method for managing multiple terminal management actions on wireless terminal 20. The parser 400 at block 710 receives terminal condition information 26 and action data 46 associated with multiple corresponding terminal management actions. Accordingly, each of the multiple action data 46 identifies a corresponding terminal management action. As shown in block 720, the multiple terminal condition information includes multiple attribute data 44 associated with corresponding action data 46. The terminal condition information includes condition data 42 associated with corresponding attribute data 44.

Attribute monitor 440 receives current terminal attribute values 460 at block 740 in response to the attribute monitor 440 receiving the multiple attributes for each corresponding terminal management action. At block 750, in one embodiment, the task manager 450 schedules each terminal management action for execution in accordance with the condition data 42. At step 760, task manager 450 compares each current terminal attribute value with the corresponding received-condition data 42 to determine if the condition data 42 is met. If the terminal management action is executed at a later time, then the current terminal attribute values 460 may be updated, if necessary, at block 760, to determine whether the current terminal attribute value 460 reflects the state of the attribute. The task manager 450 at block 770 conditionally executes each of the multiple terminal management actions if the condition data 42 associated with the corresponding terminal management action is satisfied. In one embodiment, the condition data 42 requires that a previous terminal management action is executed.

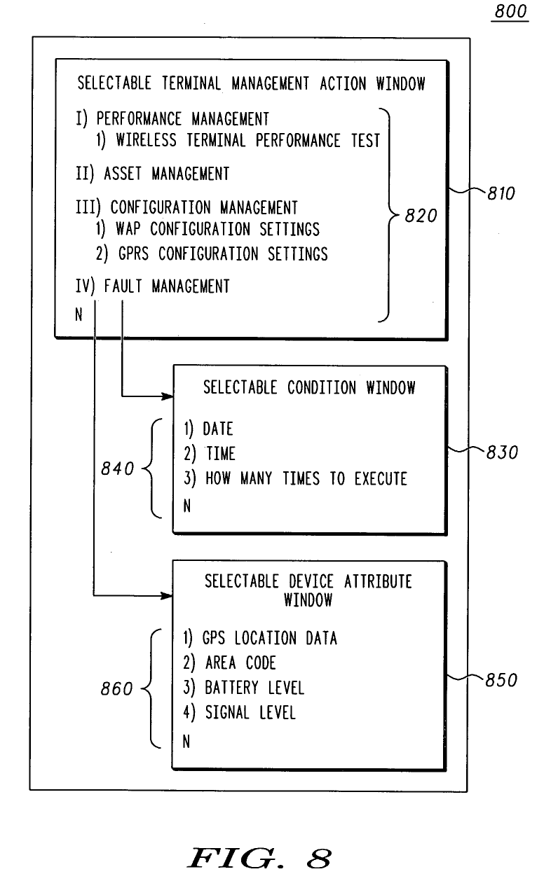

FIG. 8 illustrates a selectable terminal management action window 800 for the terminal management network element 100, as shown in FIG. 1. As previously stated, the wireless terminal condition-based control information generator 120 generates extensible markup language code that includes wireless terminal condition-based control information 16. This may be generated by an operator through the selectable terminal management action window 800, as shown in FIG. 8. For example, a user may select a type of terminal management action from options displayed on a window menu, as shown in FIG. 8, to perform terminal management operations within the terminal management categories such as (i) performance management, (ii) asset management, (iii) configuration management, and (iv) fault management. Accordingly, an operator may select one of these terminal management actions from the selectable terminal management action window. As a result, the wireless terminal condition-based control information generator 120 generates selected action data 820 based on the selectable action data associated with a terminal management action for at least one wireless mobile terminal.

Once a selection is made from the selectable terminal management action window 810 in one embodiment, a selectable condition pull-down window 830 may then be presented to the user for selection of the desired condition associated with the selected action. The wireless terminal condition-based control information generator 120 then generates selected condition data based on the selectable condition data where the selected condition data is associated with the selectable action data. Similarly, a user may select an attribute associated with the desired action through a selectable device attribute pull-down menu window 850. Accordingly, the wireless terminal condition-based control information generator 120 produces selected attribute data based on the selectable attribute data wherein the selected attribute data is associated with the selectable action data. Once the selected action data, selected condition data, and the selected attribute data are identified through, for example, an operator making appropriate selections through the user interface, as shown in FIG. 8, then the wireless terminal condition-based control information generator 120 may generate the extensible markup language code for identifying the wireless terminal condition-based control information 16.

In another embodiment, the wireless terminal condition-based control information generator 120 generates multiple terminal management actions defined by corresponding action data 46. As previously discussed with respect to the execution of multiple terminal management actions in a wireless terminal 20, the execution of a first terminal management action may be conditioned on the execution of a second terminal management action. In another embodiment, as previously discussed with regards to running tests on wireless terminal devices within the 847 area code, the operator may desire to stop execution of the test when, for example, the first 100 mobile terminals have responded with test results to the terminal management network element 100. For example, the test may be a performance monitoring activity in a particular area such as a dropped call measurement in the 847 area code, by the wireless terminal. In this example, the terminal management network element 100 may transmit a network attribute value to the wireless terminal 20 in order to allow the task manager in each respective wireless terminal 20 to compare the network attribute value with the selected condition data to determine if the selected condition is met. For example, the network attribute value may be a current number of responses under one hundred, such as eighty-two. The task manager will then compare the network attribute value eighty-two with the condition data one hundred in order to determine if the first one hundred wireless mobile telephone devices have completed the test in this example. Since in this example the network attribute value eighty-two, is less than the condition data one hundred, the condition data is not satisfied, and the terminal management action continues execution.

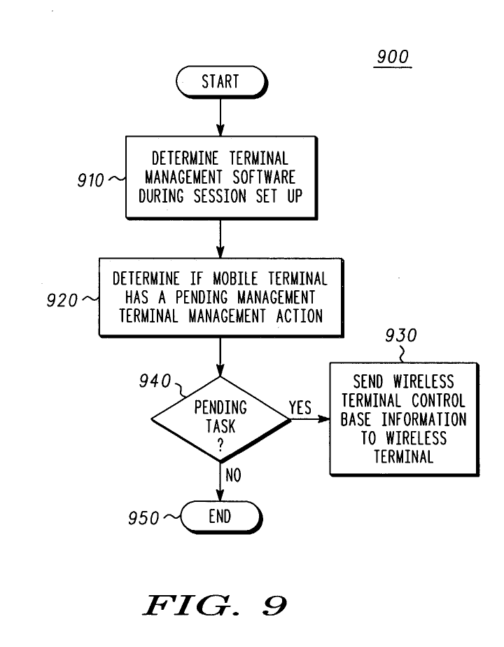

In another embodiment, as shown in FIG. 9, during session setup as shown in block 910, the wireless terminal determines if multiple terminal management actions are in operation. At block 920, the wireless terminal determines if a terminal management action is currently pending. If the wireless terminal has a pending terminal management action, then the terminal management network element 100 sends the wireless terminal condition-based control information 16 to the wireless terminal 20 at block 930. If there is no pending task at block 940, then the wireless terminal condition-based control information 16 is not sent to the wireless mobile terminal 20. In this way, the terminal management network element 100 can determine if the wireless terminal condition-based control information 16 is required to be sent to the wireless mobile terminal 20.

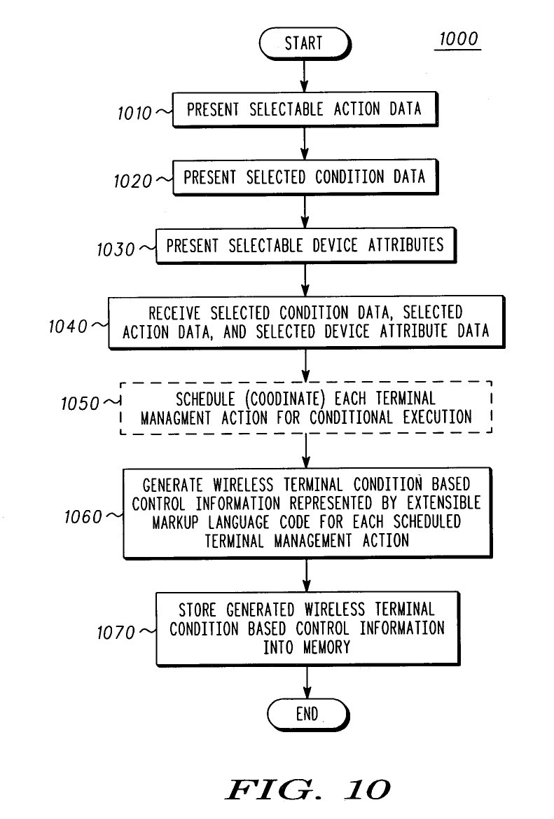

FIG. 10 illustrates a method 1000 for managing at least one wireless terminal 20 on a terminal management network element 100. At block 1010 the terminal management network element 100 presents selectable action data associated with a terminal management action for selection by a user, such as through the selectable terminal management action window 810 of FIG. 8. The wireless terminal condition-based control information generator 120 presents selectable condition data associated with a terminal management action at block 1020 where the selected condition data is associated with the selected action data. At block 1030, the terminal management network element 100 presents selectable attribute data associated with the selectable action data where the selected attribute data is associated with the selected action data. The selected condition data, selected action data, and selected device attribute data is received by the wireless terminal condition-based control information generator 120 at block 1040 for generating the wireless terminal condition-based control information 16.

Optionally, if the operator desires that the terminal management actions are to be executed according to a schedule, the operator selects the condition data 42 to reflect the desired schedule at step 1050. The wireless terminal condition-based control information generator 120 generates the wireless terminal condition-based control information 16 according to the selected action data 46, the selected condition data 42, and the selected attribute data 40. According to one embodiment, the wireless terminal condition-based control information 16 is represented by extensible markup language code for at least one wireless terminal at block 1060. According to another embodiment, the extensible markup language code, including the wireless terminal condition-based control information for at least one wireless mobile terminal, may be transferred onto a storage medium such as a CD ROM, magnetic tape, any optical type of storage medium at step 1070.

Although, for purposes of illustration, the wireless terminal condition-based control information 16 was described with reference to the SyncML protocol, any appropriate communication protocol or extension of a protocol such as one based on XML or SNMP may be used. In addition, terminal management operation of a wireless terminal 20 may be performed in any other way, so that any terminal management actions may be associated with conditions and the corresponding condition data 42. Other advantages will be recognized by those with ordinary skill in the art.

As previously described, the system and method described may be incorporated as an extension of the existing SyncML terminal management protocol in a non-invasive manner. For example, the extension information, such as the condition data 42, attribute data 44, and action data 46 (i.e., wireless terminal condition-based control information 16) may be incorporated into the existing SyncML payload. These extensions to the existing SyncML payload are completely transparent to existing SyncML systems. As a result, systems capable of receiving the extension information will extract and interpret the extension information, while older systems will merely discard the extension information without error. Additionally, the extension to the existing SyncML protocol is extensible, and can therefore be easily customized or enhanced to address new requirements and criteria.

The system and method allows an operator of the communication system 10 to control the management functions of wireless terminals 20 individually on a per-terminal basis rather than by enforcing a management function on all terminals. Additionally, since the responsibility for terminal management execution and for the execution of multitasking multiple terminal management actions occurs within the wireless terminal 20 rather than in the terminal management network element 100, execution of a terminal management action is more likely to execute successfully. Since execution of the terminal management action on the terminal management network element 100 may be interrupted or aborted if the radio access network 22 becomes unavailable, processing of the terminal management actions by the wireless terminal 20 would be independent of the radio access network 22. As a result, reliability of the communication system 10 is improved because the wireless terminal 20 executes the terminal management actions independently from the terminal management network element 100, even if access to the radio access network 16 is unavailable (i.e., in an area without signal).

Another advantage includes the ability of the wireless terminal 20 to be self-adaptive to reflect changes on the specific terminal. Other advantages include a reduction in bandwidth for performing terminal management actions on the wireless terminal 20 rather than on the terminal management network element 100. As a result, high data rate communication over the radio access network 22 for performing the terminal management operation is not required, and therefore, a reduction in communication bandwidth is realized. Consequently, the cost and effort associated with wireless terminal management is reduced.

It should be understood that the implementation of other variations and modifications of this invention and its various aspects will be apparent to those of ordinary skill in the art, and that the invention is not limited by specific embodiments described. It is therefore contemplated to cover by the present invention, any and all modifications, variations, or equivalents that fall within the spirit and scope of the basic underlying principles disclosed and claimed herein.

We claim:

1. A method in a wireless terminal comprising:
determining that a condition associated with at least one terminal management action is satisfied based on extensible markup language code that includes at least wireless terminal condition-based control information that includes at least terminal condition information and action data wherein the action data identifies the at least one terminal management action associated with the wireless terminal; and
executing conditionally, by the wireless terminal, the terminal management action identified by the received action data.

2. The method of claim 1 wherein determining that the condition associated with at least one terminal management action is satisfied based on extensible markup language code that includes at least wireless terminal condition-based control information includes: attribute data associated with the action data; and condition data associated with the attribute data.

3. The method of claim 2 comprising:
obtaining current terminal attribute values in response to the received attribute data at the wireless terminal; and
comparing the obtained current terminal attribute values to the condition data to determine if the condition data is met.

4. The method of claim 2 comprising:
scheduling a current terminal management action to conditionally execute according to terminal condition information; and
conditionally executing the current terminal management action if the condition data associated with the current terminal management action is met.

5. The method of claim 1 comprising:
obtaining wirelessly received wireless terminal condition-based control information including a plurality of action data corresponding to a plurality of terminal management actions, a plurality of corresponding attribute data associated with the corresponding plurality of action data, a plurality of corresponding condition data associated with the corresponding plurality of attribute data; and
obtaining a plurality of current terminal attribute values in response to obtaining the plurality of corresponding attribute data associated with the corresponding plurality of action data;
comparing the plurality of current terminal attribute values to the corresponding condition data to determine if the condition data is met; and
conditionally executing the plurality of terminal management actions if the condition data associated with the corresponding terminal management action is satisfied.

6. The method of claim 1 wherein, the terminal condition information associated with the terminal management action includes data representing at least one of: a wireless terminal state, a network state, a duration since a last terminal management action occurred, a number of action repetitions, a completion of a terminal management action, a software upgrade, a time of day, a terminal management action schedule, a wireless application protocol (WAP) configuration, a user setting, a signal level, a battery level, and terminal location coordinates.

7. The method of claim 1 where the wireless terminal condition-based control information includes at least one of an assert command, schedule command, perform command, and guard command, wherein:
the assert command associates the terminal condition information with the received action data and with exception action data if the condition data is not satisfied;
the schedule command associates the terminal condition information with data including at least one of a time of day, a time interval between successive executions of the terminal management action, number of repetitions to execute the terminal management action, repetition rate of executing the terminal management action, monitoring, measuring and reporting an elapsed period of time to perform a terminal management action, and a first run of a scheduled execution of a terminal management action;
the perform command associates action data with an attribute value including at least one of a network attribute value, and a wireless mobile terminal attribute value; and
the guard command identifies the terminal condition information with a guard attribute.

8. A wireless terminal comprising:
a wireless transceiver that receives extensible markup language code that includes at least wireless terminal condition-based control information that includes at least terminal condition information and action data wherein the action data identifies at least one terminal management action associated with the wireless mobile terminal; and
a wireless terminal condition-based controller, coupled to the wireless transceiver;
the wireless terminal condition-based controller for:
determining whether a condition associated with the terminal management action is satisfied, based on the terminal condition information; and
executing the terminal management action identified by the action data if the condition associated with the terminal management action is satisfied.

9. The wireless terminal condition-based controller of claim 8 comprising:
a command parser coupled to the wireless transceiver to parse the wireless terminal condition-based control information to identify the terminal condition information and the action data associated with the terminal management action.

10. The wireless terminal of claim 9 wherein the wireless terminal condition-based controller comprises:
a policy reader coupled to the command parser to read the action data, attribute data, and condition data associated with the terminal management action;
an attribute monitor coupled to the policy reader to receive attribute data from the policy reader and to obtain current terminal attribute values in response to the received attribute data; and
a task manager coupled to the policy reader and to the attribute monitor to compare the current terminal attribute values from the attribute monitor, with the received condition data to determine if the condition data is satisfied.

11. The wireless terminal of claim 10 wherein the task manager:
schedules a current terminal management action to execute according to whether a previous terminal management action is completed; and
conditionally executes the current terminal management action in accordance with the condition data associated with the current terminal management action, wherein the condition data requires that a previous terminal management action is executed.

12. The wireless terminal of claim 8 wherein the wireless terminal condition-based controller comprises:
a processing device;
memory containing executable instructions that causes the processing devices to:
identify the at least wireless terminal condition-based control information that includes the at least terminal condition information and the action data wherein the action data identifies at least one terminal management action associated with the wireless mobile terminal; and
in response to determining that the condition associated with the terminal management action is satisfied based on the terminal condition information, conditionally execute the terminal management action identified by the action data.

13. The wireless terminal of claim 8 wherein the terminal condition information associated with the terminal management action is determined at an event selected from the group consisting of a polling event, an interrupt event, a predetermined time of day, and a predetermined period of elapsed time.

14. The wireless terminal of claim 8 where the extensible markup language code includes at least one of an assert command, a schedule command, perform command, and guard command wherein:
the assert command associates the terminal condition information with the received action data and associates the terminal condition information with exception action data if the condition data is not satisfied;
the schedule command associates the terminal condition information with data including at least one of a time of day, time interval between successive executions of the terminal management action, number of repetitions to execute the terminal management action, repetition rate of executing the terminal management action, monitoring, measuring and reporting an elapsed period of time to execute the terminal management action, and a first run of a scheduled execution of a terminal management action;
the perform command associates the action data with an attribute value including at least one of a network attribute value and an attribute value associated with the wireless mobile terminal; and
the guard command modifies the terminal condition information with a guard attribute.

15. The wireless terminal of claim 8 wherein the wireless terminal condition-based control information identifies a plurality of terminal management actions, wherein the wireless terminal executes the plurality of terminal management actions in accordance with the corresponding terminal condition information wherein the terminal condition information requires that a plurality of previous terminal management actions is executed;
wherein, the terminal condition information associated with plurality of terminal management actions includes data representing at least one of: a wireless terminal state, a network state, a duration since a last terminal management action occurred, a number of action repetitions, a completion of a terminal management action, a software upgrade, a time of day, a terminal management action schedule, a wireless application protocol (WAP) configuration, a user setting, a signal level, a battery level, and terminal location coordinates.

16. A storage medium having stored therein instructions executable by a processor that causes the processor to:
receive, extensible markup language code that includes at least wireless terminal condition-based control information that includes at least terminal condition information and action data wherein the action data identifies at least one terminal management action associated with the wireless mobile terminal; and
in response to determining that a condition associated with the terminal management action is satisfied based on the terminal condition information, conditionally execute, by the processor, the terminal management action identified by the action data.

17. A terminal management network element comprising:
a wireless terminal condition-based control information generator that generates extensible markup language code that includes wireless terminal condition-based control information that includes:
selected action data based on selectable action data associated with a terminal management action for at least one wireless mobile terminal;
selected condition data based on selectable condition data wherein the selected condition data is associated with the selectable action data; and
selected attribute data based on selectable attribute data wherein the selected attribute data is associated with the selectable action data;
wherein the wireless terminal condition-based control information is generated according to the selected action data, the selected condition data and the selected attribute data; and
a transceiver coupled to the wireless terminal condition-based control information generator to transmit the wireless terminal condition-based control information.

18. The terminal management network element of claim 17 wherein the wireless terminal condition-based control information generator generates a plurality of terminal management actions defined by a plurality of action data;
wherein the terminal management network element defines condition data associated with a first terminal management action to conditionally execute according to whether a plurality of terminal management actions completes execution; and
wherein, the terminal condition information associated with the plurality of terminal management actions includes data representing at least one of: a wireless terminal state, a network state, a duration since a last terminal management action occurred, a number of action repetitions, a completion of a terminal management action, a software upgrade, a time of day, a terminal management action schedule, a wireless application protocol (WAP) configuration, a user setting, a signal level, a battery level, and terminal location coordinates.

19. The terminal management network element of claim 17 wherein the wireless management terminal network element generator:
generates wireless terminal condition-based control information to conditionally execute a plurality of terminal management actions each associated with corresponding selected condition data on a plurality of wireless mobile terminals; and
sends network attribute values to the plurality of wireless mobile terminals to compare the network attribute values with the selected condition data to determine if the selected condition data is met.

20. A method for managing at least one wireless mobile terminal by a terminal management network element comprising:
presenting selectable action data associated with a terminal management action;
receiving selected action data in response to presenting the selectable action data;
presenting selectable condition data associated with the selectable action data wherein the selected condition data is associated with the selected action data;
receiving selected condition data in response to presenting the selectable condition data;
presenting selectable attribute data associated with the selectable action data wherein the selected attribute data is associated with the selected action data;
receiving selected attribute data in response to presenting the selectable attribute data; and
generating wireless terminal condition-based control information according to the selected action data, the selected condition data, and the selected attribute data wherein the wireless terminal condition-based control information is represented by extensible markup language code for the at least one wireless mobile terminal.

21. The method of claim 20 wherein the selected action data identifies a plurality of terminal management actions, the method comprising:
associating selected condition data with a first terminal management action to conditionally execute the first terminal management actions on a single wireless terminal; and
generating the plurality of current terminal management actions associated with the selected condition data.

22. The method of claim 20 comprising:
generating wireless terminal condition-based control information for a plurality of wireless mobile terminals; and
sending network attribute values to the plurality of wireless mobile terminals to allow comparing the network attribute values with the selected condition data by each of the plurality of wireless mobile terminals to determine if the selected condition data is met.

23. A terminal management system comprising:
a terminal management network element comprising:
a wireless terminal condition-based control information generator that generates wireless terminal condition-based control information comprising:
selected action data based on selectable action data associated with a terminal management action to execute on at least one wireless mobile terminal;
selected condition data based on selectable condition data wherein the selected condition data is associated with the selected action data;
selected attribute data based on selectable attribute data wherein the selected attribute data is associated with the selected action data;
wherein the wireless terminal condition-based control information is generated according to the selected action data, the selected condition data and the selected attribute data, wherein the wireless terminal condition-based control information is represented by extensible markup language code;
at least one wireless terminal comprising:
a wireless transceiver that receives the at least wireless terminal condition-based control information, the selected attribute data, the selected condition data, the selected action data and the terminal management action associated with the wireless mobile terminal; and
a wireless terminal condition-based controller, operatively coupled to the wireless transceiver, and operative to:
determine that the selected condition data associated with the terminal management action is satisfied: and
conditionally execute the terminal management action identified by the selected action data if the selected condition data associated with the terminal management action is satisfied.

24. The terminal management system of claim 23 wherein the wireless terminal condition-based control information generator generates, a plurality of terminal management actions defined by the selected action data and the associated selected condition data, and defines the selected condition data associated with each terminal management action to conditionally execute in accordance with the selected condition data associated with each respective terminal management action.
